(19) United States
(12) Patent Application Publication
(10) Pub. No.: US 2007/0246659 A1
(43) Pub. Date: Oct. 25, 2007

(54) Method for operating a laser scanning microscope

(76) Inventors: Helmut Bloos, Jena (DE); Gunter Moehler, Jena (DE)

Correspondence Address: JACOBSON HOLMAN PLLC, 400 SEVENTH STREET N.W., SUITE 600, WASHINGTON, DC, 20004, US

(21) Appl. No.: 11/783,428

(22) Filed: Apr. 9, 2007

(30) Foreign Application Priority Data
Apr. 7, 2006 (DE) 10 2006 016 927.1

(51) Int. Cl. G01N 21/64

(52) U.S. Cl. 250/459.1

(57) ABSTRACT

Method for operating a Laser Scanning Microscope, in which a probe is illuminated by at least one scanner and a picture recording takes place with a temperature measurement taking place in the scanner and/or in the scanner driver and only on reaching a threshold temperature a cooling device is started and advantageously on switching on of the cooling device the picture recording is interrupted or on reaching a threshold temperature a display device actuates an optical or an acoustic display.

### BACKGROUND OF THE INVENTION

(1) Field of the Invention

The present invention relates to a method for operating a Laser Scanning Microscope (LSM), in which a probe is illuminated by at least one scanner and a picture recording takes place.

(2) Description of Related Art

In some applications of the LSM, it is necessary to work with very high scanning speeds in order to record fast processes, such as, for instance, in the observation of extremely fast processes in physiology.

An LSM is essentially composed of four modules as shown in FIG. 1: Light source, scanning module, detection unit and microscope. These modules are described in detail in DE19702753A1 which is incorporated by reference herein.

For the specific excitation of different dyes in a preparation, different wavelengths are used in an LSM laser. The selection of the excitation wavelengths depends on the absorption characteristics of the dye to be investigated. The excitation radiation is generated in the light source module. Thereby, many different lasers are employed (argon, argon krypton, TiSa laser). Furthermore, the selection of the wavelengths and the adjustment of the intensity of the required excitation wavelengths take place in the light source module, for example, by using an acousto-optical crystal. After that, the laser beam reaches, passing through a fiber or a suitable mirror arrangement, into the scanning module.

The laser beam generated in the light source is focused diffraction limited on the preparation by means of an objective, passing through the scanner, scan optics, and the tube lens. The focus performs point scanning of the probe in x-y direction. The dwell times of the pixel during the scanning of the probe lie mostly in the range of less than one microsecond to a few seconds.

In confocal detection (descanned detection) of fluorescence light, the light, which is emitted from the focal plane (specimen) and from the planes lying above and below it, reaches a dichroic beam splitter (MDB) passing through a scanner. The latter separates the fluorescence light from the excitation light. Thereafter, the fluorescence light is focused on an aperture diaphragm (confocal diaphragm/pinhole), which lies in a plane exactly conjugate to the focal plane. Thereby the portions of fluorescent light outside the focus are suppressed. By varying the size of the aperture, the optical resolution of the microscope can be adjusted. Behind the diaphragm, there is another dichroic block filter (EF), which suppresses the excitation radiation again. After passing through the block filter, the fluorescence light is measured by means of a point detector (PMT).

In multiphoton absorption, the excitation of the dye fluorescence takes place in a small volume in which the excitation intensity is particularly high. This region is only insignificantly larger than the detected region, if a confocal arrangement is used. The use of a confocal diaphragm can thus be omitted and the detection can take place directly after the objective (non-descanned detection).

In an another arrangement for the detection of dye fluorescence excited with multiphoton absorption, descanned detection does take place like before, however in this case the pupil of the objective is imaged into the detection unit (non-confocal descanned detection).

In both of the detection arrangements for a three-dimensionally illuminated image with the corresponding one-photon or multiphoton absorption, only that plane (optical section) is reproduced which lies in the focal plane of the objective. By recording several optical sections in the x-y plane at different depths z, a three-dimensional image of the probe can subsequently be generated with computer-aided processing.

An LSM is thus suitable in the examination of thick preparations. The excitation wavelengths are determined by the used dye according to its specific absorption characteristics. The dichroic filters tuned for the emission characteristics of the dye ensure that only the fluorescence light emitted from the respective dye is measured by the point detector.

In biomedical applications, nowadays several different cell regions with different dyes are marked at the same time (multifluorescence). The individual dyes can be detected in the prior art separately either on the basis of the different absorption characteristics or emission characteristics (spectra). For that reason, additional splitting of the fluorescence light from several dyes is done with additional dichroic beam splitters (DBS) and the separate detection of the individual dye emissions takes place in separate point detectors (PMT x).

The LSM LIVE manufactured by Carl Zeiss MicroImaging GmbH realizes a very fast line scanner with image generation of 120 images per second. See for example: (http:H//www.zeiss.de/c12567be00459794/Contents-Frame/fd9fa0090eee01a641256a550036267b).

However, in very fast scanning processes, one must take into account that high scanning speeds lead to heavy heating of the scanner and the scan drive. In the VM500 Scanner manufactured by GSI Lumonics for example, a temperature of 50° C. must not be exceeded in the scanner. Even when these scanners are provided with a scanner heater in order to maintain a constant scanner temperature so as to improve the drift behavior, a cooling option is however not provided by the manufacturer.

In practice the scanners are usually insulated by means of appropriate fixtures or are accommodated in the housing with direct connection with the material in as oscillation-free manner as possible. Thereby the additional structures are usually selected so that appropriate removal of heat is possible.

This is achieved, for instance, by means of the correspondingly large metal areas, which are connected with the fastening fixture of the scanner. Thus the corresponding temperature gradient is generated and heat removal is maintained. The disadvantage thereby is that the additional structures become very heavy and voluminous. These features of the scanning devices are disadvantageous in most applications because the scanning devices are integrated in the optical systems, which should have smaller, and not larger, mass and volume.

Moreover, increase in the scanning speeds leads to increase in consumed power, which, on its part, requires that there is better cooling. At present, the heat losses are conveyed through heat pipes or Peltier elements and, in extreme cases, also by means of water cooling. The complexities in the layout are considerable and result in very large additional structures.

### BRIEF SUMMARY OF THE INVENTION

The aim of this invention is to avoid these disadvantages herein described above. In describing preferred embodiments of the present invention illustrated in the drawings, specific terminology is employed for the sake of clarity. However, the invention is not intended to be limited to the specific terminology so selected, and it is to be understood that each specific element includes all technical equivalents that operate in a similar manner to accomplish a similar purpose.

In course of normal operation, a scanner is not subjected to overload on average. The power consumed can be discharged through a construction that is adapted for the normal case, and not to the case of maximum requirements. High-speed applications are needed rarely and mostly for a short period, because even when the aim is to record the defined processes that are fast, such measurements demand corresponding long phase of preparations. During that period, the scanner cannot be used or can be exposed to only an insignificant load so that it can cool down to its rated temperature. In their specifications, the scanners are provided with high dynamic capacity. Thereby it is pointed out that the maximum temperature of the scanner must not be exceeded. However, if the temperature of the scanner and the scan drive are monitored, execution of short-time, high-speed scanning is possible without exceeding the temperature limits.

This state is achieved through a combination of the measurements, according to the invention, of the temperature of the scanner and the scan drives, and regulation of a fan according to the requirements of the measuring system. During a high-speed scan, the fan used for the cooling of the scan-drive is switched off, with the advantage that the possible shocks due to the fan and the turbulences during the measurements, which have an unfavorable effect on the optical path, can be avoided. With this method one can have the advantage that the elaborate methods for cooling, such as, for example, water cooling, Peltier cooling and similar methods, can be dispensed with and a simple fan can be employed.

In the scan system, a combined temperature-fan-control system is advantageously used. The combined temperature-fan-control system is in a position to monitor both the temperature of the scanner through continuous measurement by means of scanner-internal temperature sensors, as well as to regulate the temperature of the scan drive by using an external fan regulator circuit connected thermally with the heat sink of the drive. This fan regulator circuit (Fan Controller) is provided with its own temperature registration and switches a fan on or off according to the specified temperature thresholds, whereby these switching processes can be enabled or blocked also through an external switching signal.

In this way, several measuring and regulating processes run at the same time. The regulation and the registration of the measured values are thereby guided by various independent processes. On one hand, the relationship of the temperature with the scanning speed is handled in a closed computer system, and on the other hand, the fan is driven by its own separate control, which can also be externally manipulated despite that. It is thus possible to protect the system according to the invention. The combination of the measurement points and their evaluation in connection with the scan control regime used by the user leads to an economical solution providing a scanning system with greater dynamics.

The economical solution is achieved through the use of a fan with the mentioned temperature-measurement system, which is switched on only if the temperature in the heat sink of the scan drive exceeds a certain upper threshold value. This kind of temperature registration enables a variable scan regime, in which the scanner as well as the drive can be operated for a short period with up to near-threshold values without the risk of a thermal destruction. The internal threshold temperature of the scanner is measured on real-time basis during the scanning by querying the internal temperature sensor through an Analog-to-Digital Converter (ADC). If the threshold value is exceeded during the scanning, a message is sent out and the high speed scanning is defined as stopped. If the lowest temperature threshold is crossed, for a short period a new high speed scan can be allowed. The temperature of the drive is registered by means of the sensor of the fan control and compared internally with the threshold. On reaching the threshold temperature, the fan is automatically switched on and the user receives a message that the fan is switched on.

For an overview scan, in which only the adjustment processes take place, the fan can be operated continuously, even with different speeds, which ensures adequate cooling and yet causes only little noise due to wind. The interplay between the measured internal temperature and the threshold temperature curve of the scanner, which is stored in the computer, and the external temperature in combination with the fan, brings advantages in the construction and the layout of the scanning unit in the system.

### BRIEF DESCRIPTION OF THE DRAWINGS

FIG. 1 is a schematic diagram of a laser scanning microscope.

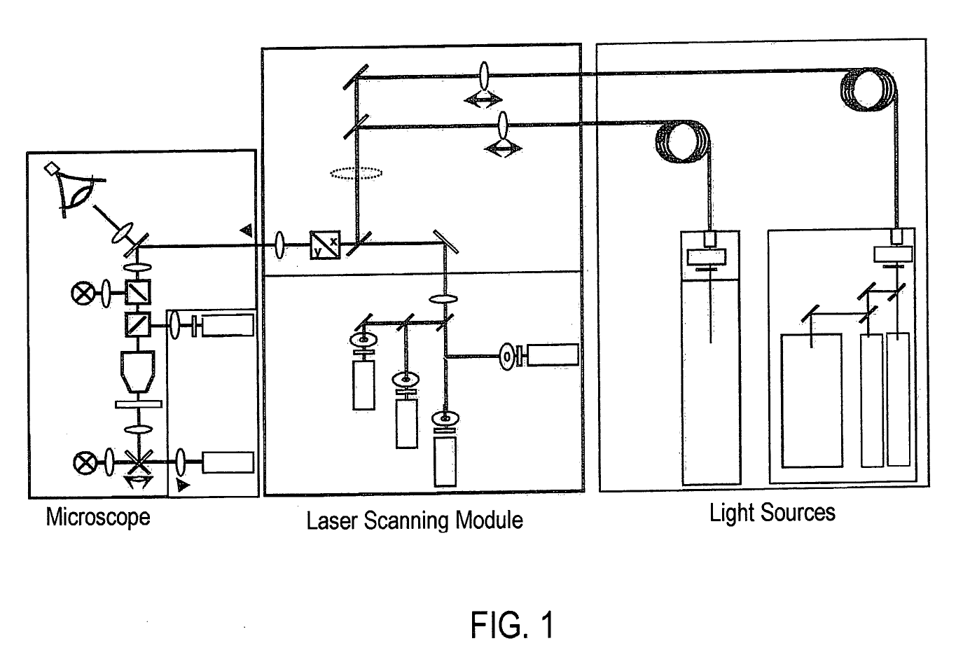

FIG. 2 is a schematic diagram of a preferred embodiment of the present invention.

### DETAILED DESCRIPTION OF THE INVENTION

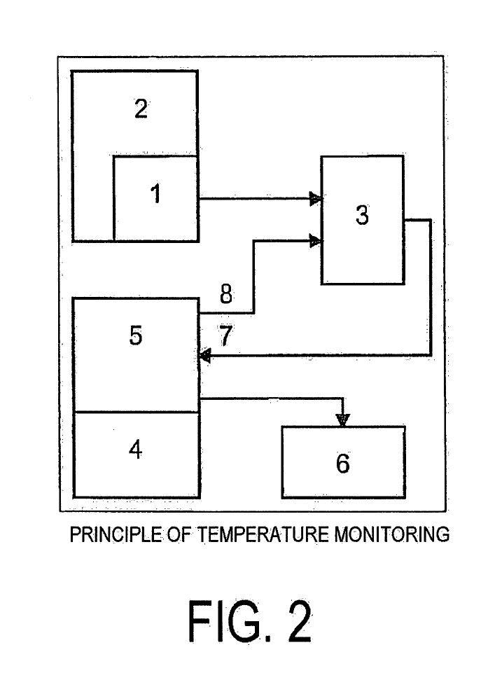

The invention is explained in greater detail on the basis of the schematic drawing in FIG. 2.

The temperature sensor 1 in the scanner 2 registers the temperature of the scanner by means of a micro-switch 3 at sufficiently short time intervals. The recording of the temperature of the scan drive heat sink 4 takes place through a fan controller 5 thermally coupled with it, which, in dependence of the heat sink temperature, switches a fan 6 on or off, or regulates the fans rpm by means of pulse-width modulation (PWM). Through the switch input 7 in the fan controller 5, the microcontroller 3 can generate a Disable command for the fan 6. The fan controller 5 includes an over-temperature output 8, which is activated on exceeding a certain temperature above the fan switch-on temperature. The over-temperature output 8 is connected to an input of the microcontroller.

If the temperature of the scan drive heat sink 4 rises as a result of a high speed scan to such an extent that the over-temperature output 8 is active, the Disable command at the switch input 7 is cancelled by the microcontroller 3—whereupon the fan 6 runs with maximum power and thus reduces the heat sink temperature again. If the temperature of the scanner 2 reaches 50° C., the scan is discontinued and can be started again, only if the temperature falls below a certain temperature (software hysteresis).

In the scan system, a combined temperature-fan-control system is advantageously used. The combined temperature-fan-control system is in a position to monitor both the temperature of the scanner 2 through continuous measurement by means of scanner-internal temperature sensors, as well as to regulate the temperature of the scan drive by using an external fan regulator circuit 5 connected thermally with the heat sink 4 of the drive. This fan regulator circuit (Fan Controller) 5 is provided with its own temperature registration and switches the fan 6 on or off according to the specified temperature thresholds, whereby these switching processes can be enabled or blocked also through an external switching signal.

The economical solution is achieved through the use of a fan 6 with the mentioned temperature-measurement system, which is switched on only if the temperature in the heat sink 4 of the scan drive exceeds a certain upper threshold value. This kind of temperature registration enables a variable scan regime, in which the scanner 2 as well as the drive can be operated for a short period with up to near-threshold values without the risk of a thermal destruction. The internal threshold temperature of the scanner 2 is measured on real-time basis during the scanning by querying the internal temperature sensor through an Analog-to-Digital Converter (ADC). If the threshold value is exceeded during the scanning, a message is sent out and the high speed scanning is defined as stopped. If the lowest temperature threshold is crossed, for a short period a new high speed scan can be allowed. The temperature of the drive is registered by means of the sensor of the fan control 5 and compared internally with the threshold. On reaching the threshold temperature, the fan 6 is automatically switched on and the user receives a message that the fan is switched on.

The high speed scans should be so limited in time that the aforementioned cases do not arise, because only then interference-free scanning operations can be ensured. By means of a connected personal computer (PC), the temperature curve of the scanner as well as the fan status can be graphically displayed for the operator.

It is to be understood that the present invention is not limited to the embodiment described herein. Modifications and variations of the above-described embodiments of the present invention are possible, as appreciated by those skilled in the art in light of the above teachings. It is therefore to be understood that, within the scope of the appended claims and their equivalents, the invention may be practiced otherwise than as specifically described.

1. A method for operating a Laser Scanning Microscope comprising the steps of:
illuminating a probe by at least one scanner having a scanner driver;
recording a picture;
measuring a temperature in the scanner and/or in the scanner driver and
staring a cooling device only when the measured temperature has reached a predetermined threshold temperature.

2. The method according to claim 1, wherein when the cooling device is switched on, the picture recording step is interrupted.

3. A method for operating a Laser Scanning Microscope, comprising the steps of:
illuminating a probe by at least one scanner having a scanner driver;
recording a picture;
measuring a temperature in the scanner and/or in the scanner driver and
interrupting the picture recording and shutting down the scanner when the measured temperature has reached a predetermined threshold temperature.

4. A method for operating a Laser Scanning Microscope, comprising the steps of:
illuminating a probe by at least one scanner having a scanner driver;
recording a picture;
measuring a temperature in the scanner and/or in the scanner driver and
providing an optical or an acoustic display when the measured temperature has reached a predetermined threshold temperature.

5. The method according to claim 4, whereby the display device displays
(a) that the threshold temperature has been reached and/or
(b) the time necessary for cooling down of the scanner and/or the scanner driver has occurred.

6. The method according claim 1, whereby the measurement of the temperature takes place directly in the scanner and a continuous comparison with a stored threshold value curve for that scanner takes place during the scan in the computer.

7. The method according to claim 1, whereby a picture recording takes place till a threshold temperature is reached.
